(19) United States
(12) Patent Application Publication
(10) Pub. No.: US 2025/0077820 A1
(43) Pub. Date: Mar. 6, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: TETSUHIDE TAKASAKI, Tokyo (JP)

(21) Appl. No.: 18/795,975

(22) Filed: Aug. 6, 2024

(30) Foreign Application Priority Data
Aug. 30, 2023 (JP) 2023-139879

(51) Int. Cl. G06K 15/02; G06K 15/00

(52) U.S. Cl. CPC G06K 15/024; G06K 15/005; G06K 15/1867; G06K 15/403

(57) ABSTRACT

An information processing apparatus edits print data including cut line layer data used in die cutting of a printed medium, and includes one or more processors and/or circuitry which function as: an obtaining unit configured to obtain print region information including at least a paper feeding amount in inter-page printing from a printing apparatus configured to perform the printing on the print medium and obtain operation characteristic information of a die cutting apparatus from the die cutting apparatus; and a determination unit configured to determine the cut line layer data based on the print region information and the operation characteristic information.

### BACKGROUND OF THE INVENTION

### Field of the Invention

The present disclosure relates to a technique of handling data used in die cutting after printing.

### Description of the Related Art

A configuration is known in which, after a printing apparatus forms an image on a print medium, a half cut (hereinafter, referred to as “die cut”) is formed in an outline portion of the image by using a die cutting apparatus to cut out a portion of the formed image. The die cutting apparatus generates a cut line forming the die cut based on print data used by the printing apparatus. Japanese Patent Laid-Open No. 2022-012729 discloses a control method of generating a cut line by using print data used by a printing apparatus.

### SUMMARY OF THE INVENTION

An information processing apparatus according to the present disclosure edits print data including cut line layer data used in die cutting of a printed medium, and includes one or more processors and/or circuitry which function as: an obtaining unit configured to obtain print region information, including at least a paper feeding amount in inter-page printing, from a printing apparatus configured to perform the printing on the print medium and obtain operation characteristic information of a die cutting apparatus from the die cutting apparatus; and a determination unit configured to determine the cut line layer data based on the print region information and the operation characteristic information.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a label creation system;

FIG. 2 is a block diagram illustrating a hardware configuration of a printing apparatus;

FIG. 3 is a block diagram illustrating a hardware configuration of a die cutting apparatus;

FIG. 4 is a diagram illustrating an example of the die cutting apparatus using a rotary method;

FIG. 5 is a diagram illustrating an example of the die cutting apparatus using a flat die cutting method;

FIG. 6 is a block diagram illustrating an example of a control system of the die cutting apparatus;

FIG. 7 is a diagram illustrating an example of a software configuration of the label creation system;

FIGS. 8A, 8B, and 8C are diagrams illustrating an example of label data created by a design application;

FIG. 9 is a diagram illustrating an example of a screen of a label application;

FIG. 10 is a flowchart illustrating print job saving processing;

FIG. 11 is a diagram illustrating an example of print region information of the printing apparatus;

FIG. 12 is a diagram illustrating examples of a print data size and a paper feeding amount of the printing apparatus;

FIG. 13 is a diagram illustrating an example of an input screen of the print region information of a print region;

FIG. 14 is a diagram illustrating an example of print job data;

FIG. 15 is a diagram illustrating an example of a print setting ticket;

FIGS. 16A and 16B are flowcharts illustrating cut line layer data separation processing;

FIG. 17 is a diagram illustrating an example of an input screen of a cut line layer data size and the like;

FIG. 18 is a diagram illustrating an example of cut line layer data;

FIG. 19 is a diagram illustrating an example of an eye mark setting warning screen;

FIG. 20 is a diagram illustrating an example of an eye mark output warning screen;

FIG. 21 is a diagram illustrating an example of the print job data;

FIG. 22 is a diagram illustrating an example of an eye mark output confirmation screen;

FIG. 23 is a diagram illustrating an example of the cut line layer data; and

FIG. 24 is a diagram illustrating an example of the cut line layer data.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

### Hardware Configuration of Label Creation System

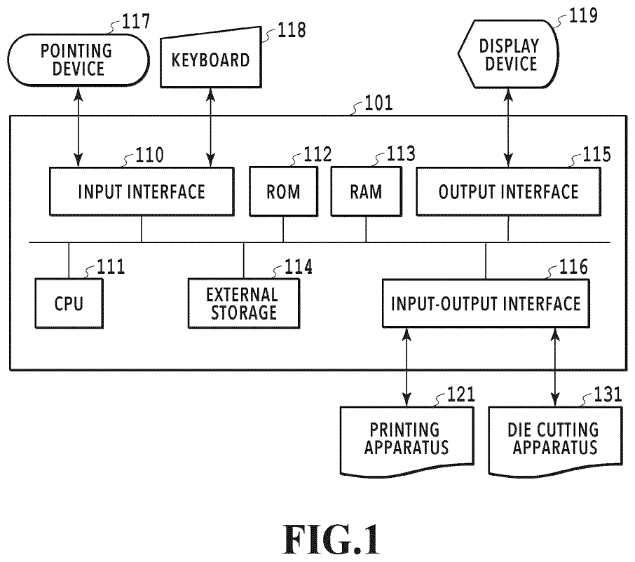

In the present embodiment, explanation is given of an example of a label creation system used in a printing step that is part of a label printing step and a die cutting step after the printing. FIG. 1 is a block diagram illustrating a hardware configuration of the label creation system. In FIG. 1, a host computer 101 is an example of an information processing apparatus, and includes an input interface 110, a CPU 111, a ROM 112, a RAM 113, an external storage 114, an output interface 115, and an input-output interface 116. Input devices such as a keyboard 118 and a pointing device 117 are connected to the input interface 110. A display device such as a display device 119 is connected to the output interface 115.

An initialization program is stored in the ROM 112. An application program group, an operating system (OS), a design application, and other various pieces of data are stored in the external storage 114. The RAM 113 is used as a work memory or the like in a case where various programs stored in the external storage 114 are executed, and the various programs can operate in the host computer 101. Note that, in the present embodiment, the CPU 111 executes functions in the host computer 101 to be described later and processes according to flowcharts to be described later by performing processes according to procedures of programs stored in the ROM 112.

A printing apparatus 121 that is a device is connected to the host computer 101 via the input-output interface 116. Plural host computers 101 may be connected to the printing apparatus 121. Although the host computer 101 and the printing apparatus 121 are configured as separate apparatuses in this example, these apparatuses may be configured as one information processing apparatus. A die cutting apparatus 131 that is a device is connected to the host computer 101 via the input-output interface 116. Note that plural host computers 101 may be connected to the die cutting apparatus 131. Although the host computer 101 and the die cutting apparatus 131 are configured as separate apparatuses in this example, these apparatuses may be configured as one information processing apparatus. Moreover, although the host computer 101, the printing apparatus 121, and the die cutting apparatus 131 are configured as separate apparatuses, these apparatuses may be configured as one information processing apparatus.

In the present embodiment, an ink jet printer configured to perform printing by ejecting liquid (ink) on a paper surface is explained as an example of the printing apparatus 121. However, printing may be executed by other methods such as an electrophotographic method. In the present embodiment, a rotary method or a flat die cutting method is explained as an example of a method of the die cutting apparatus 131. However, a cut portion may be formed by other methods (for example, laser cut method). Note that the host computer 101 may be a desktop PC, a laptop computer, a tablet terminal, or a smartphone.

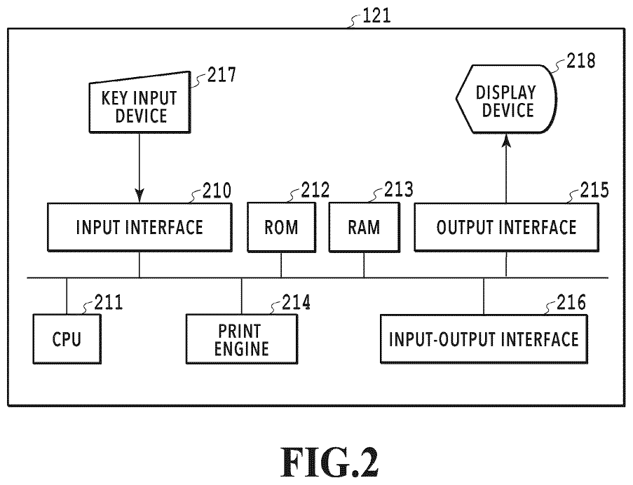

FIG. 2 is a block diagram illustrating a hardware configuration of the printing apparatus 121. The printing apparatus 121 includes an input interface 210, a CPU 211, a ROM 212, a RAM 213, a print engine 214, an output interface 215, an input-output interface 216, a key input device 217, and a display device 218. The key input device 217 receives an input operation from the user, and is formed of numeral input keys, a mode setting key, a determination key, a cancel key, and the like. The key input device 217 is connected to the input interface 210. The display device 218 displays details of received print data and a state of the printing apparatus 121, is formed of a liquid crystal display (LCD) or the like, and is connected to the output interface 215. Although the key input device 217 and the display device 218 are separate units in this example, the key input device 217 and the display device 218 may be integrated by using a touch panel.

The CPU 211 is a system control unit, and controls the entire printing apparatus 121. A control program executed by the CPU 211 and fixed data such as a data table are stored in the ROM 212. The RAM 213 is used as a work memory of the CPU 211, and is also used as a buffer for temporarily storing a print job. The print engine 214 forms an image on a print medium such as paper by using a printing agent such as liquid (ink), based on the data saved in the RAM 213 and the print job received from the host computer 101, and outputs a printed product. Connecting the input-output interface 116 of the host computer 101 and the input-output interface 216 of the printing apparatus 121 allows the host computer 101 and the printing apparatus 121 to communicate with each other. A network connection, a wireless LAN, and the like can be given as examples of a connection method of these apparatuses, but are not limited to the above.

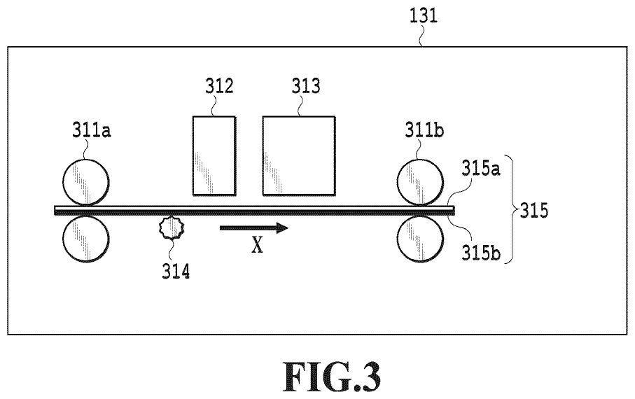

FIG. 3 is a schematic diagram illustrating a configuration of the die cutting apparatus 131. The die cutting apparatus 131 includes conveyance rollers 311a and 311b, an eye mark detection sensor 312 (detection unit), a die cutting unit 313, and a conveyance distance detection sensor 314 (rotary encoder). The conveyance rollers 311a and 311b are conveyance mechanisms that convey a print medium 315 on which an image is printed in a predetermined direction (X direction in FIG. 3). In this example, the print medium 315 is a print medium that is subjected to printing and on which an image is formed by the printing apparatus 121. The conveyance rollers 311a and 311b are connected to not-illustrated conveyance motors, and convey the print medium 315 in the predetermined direction by being driven with rotation of the conveyance motors.

The print medium 315 is a continuous sheet having a two-layer structure in which a label sheet 315a in an upper layer and a mount 315b in a layer below the label sheet 315a adhere to each other. The label sheet 315a is formed of a print layer in which an image is printed on a front surface side and an adhesive layer that is provided on the mount 315b side to adhere to the mount 315b. A surface of the mount 315b to adhere to the label sheet 315a is subjected to release treatment to protect the adhesive layer of the label sheet 315a.

The die cutting unit 313 is a die cutting unit that die-cuts the print medium 315 being conveyed by the conveyance rollers 311a and 311b. In the present embodiment, the die cutting unit 313 does not die-cut the mount 315b of the print medium 315, and die-cuts only the label sheet 315a on the mount 315b to form cuts in the label sheet 315a. The print medium 315 before being processed is set in the die cutting apparatus 131 with the label sheet wound in a roll shape. The die cutting unit 313 repeatedly die-cuts the label sheet pulled out from the roll. The label sheet processed as described above is wound again into a roll shape. One portion of the processed print medium in which the image is formed and that is die-cut is peeled off from the mount 315b, and is attached to another object as a sticker.

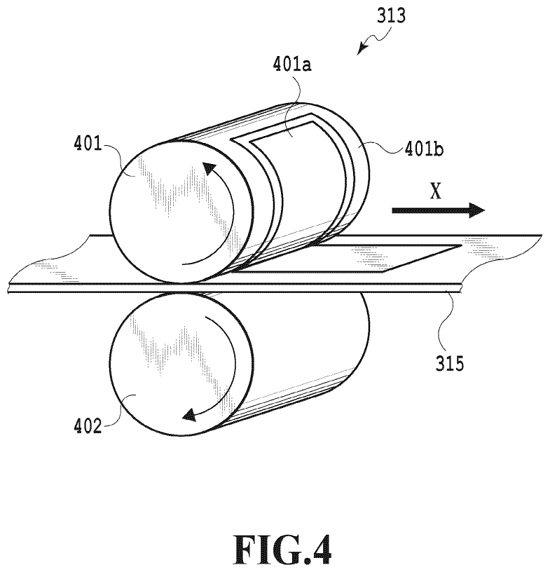

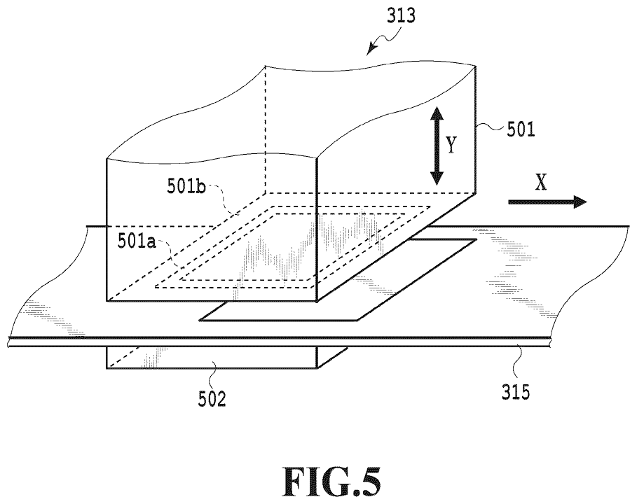

FIGS. 4 and 5 are perspective diagram schematically illustrating two configuration examples of the die cutting unit 313. FIG. 4 is an example of a die cutting apparatus using the rotary method. The die cutting unit 313 includes a die cutting roller 401 and an anvil roller 402. The die cutting roller 401 is a cylindrical roller, and includes a die cutting blade sheet 401b provided with a die cutting blade 401a that cuts and die-cuts the label sheet 315a of the print medium 315. The anvil roller 402 is a cylindrical roller, and receives the die cutting blade 401a of the die cutting roller 401. The die cutting roller 401 and the anvil roller 402 are arranged parallel to each other on the upper side and the lower side to sandwich the print medium 315, and are rotated in opposite directions by a not-illustrated drive mechanism. The print medium 315 is thereby conveyed in the X direction in FIG. 4, and the die cutting unit 313 presses the die cutting blade 401a of the die cutting roller 401 against the print medium 315, and die-cuts the label sheet 315a of the print medium 315 into a shape of the die cutting blade 401a.

Note that die cutting blade 401a is formed in such a shape and size that one or plural labels are die-cut by one rotation of the die cutting roller 401. Moreover, the die cutting blade 401a is a blade with such a depth that only the label sheet 315a in the upper layer is cut and the mount 315b in the lower layer is not cut. In the die cutting unit 313 illustrated in FIG. 4, the die cutting blade sheet 401b can be detached and attached, and the shape or size of the die cutting blade 401a can be changed by replacing the die cutting blade sheet 401b. Accordingly, the shape to be die-cut can be changed to any shape by replacing the die cutting blade sheet 401b.

An example of a procedure of creating the die cutting blade sheet 401b is described below. In the label printing, in a case where printing of one page is completed, the print medium is additionally conveyed (example of additional conveyance amount: 2 mm) in inter-page printing. This additional conveyance amount is referred to as paper feeding amount. Cut line layer data included in the print data of one page in which label data is arranged is saved in a Portable Document Format (PDF) file. Generally, the print data does not include the above-mentioned paper feeding amount. A page size of the saved PDF file is the width and height of the die cutting blade sheet 401b, and a position of a cut line drawn in this PDF file is the position of the die cutting blade 401a. Since the page height of the PDF file is the height of the die cutting blade sheet 401b (operation length of the die cutting roller 401), the following problem occurs in a case where the paper feeding amount is not reflected in the page height of the PDF file. In a case of the die cutting apparatus using the rotary method, the circumference of the die cutting roller 401 is a repeated operation length. In a case where the repeated operation length does not coincide with a repeated length of the label image printed continuously on the label sheet 315a, a desired die-cut label cannot be obtained. In the present embodiment, a length obtained by adding the paper feeding amount to the page height of the PDF file is set as the height of the die cutting blade sheet 401b to avoid occurrence of the above-mentioned problem. Specifically, the image position of the printed product and the cut position where a die cut is formed can be matched with each other in a die cut forming step after the printing.

FIG. 5 is an example of a die cutting apparatus using the flat die cutting method. The die cutting apparatus using the flat die cutting method includes the die cutting unit 313, the eye mark detection sensor 312, and the conveyance distance detection sensor 314. The die cutting unit 313 includes a flat-plate shaped die 501 and a flat-plate shaped anvil 502. The die 501 includes a die cutting blade sheet 501b provided with a die cutting blade 501a that cuts and die-cuts the label sheet 315a of the print medium 315. The anvil 502 receives the die cutting blade 501a of the die 501. The die 501 and the anvil 502 are arranged parallel to each other on the upper side and the lower to sandwich the print medium 315. The die 501 is moved by a not-illustrated drive mechanism in a direction (Y direction in FIG. 5) intersecting the X direction in which the print medium 315 is conveyed. Then, the die 501 presses the die cutting blade 501a against the print medium 315, and die-cuts the label sheet 315a of the print medium 315 into a shape of the die cutting blade 501a.

The conveyance distance detection sensor 314 illustrated in FIG. 3 is a distance detection unit that detects a conveyance distance by which the print medium 315 is conveyed by the conveyance rollers 311a and 311b. The conveyance distance detection sensor 314 is, for example, an encoder or the like. The eye mark detection sensor 312 is, for example, an image sensor using a camera, a reflective sensor using a laser beam, or the like. The eye mark detection sensor 312 detects an identification mark (eye mark) for specifying a portion of the print medium 315 to be die-cut by the die cutting unit. In a case where the eye mark is printed on the label sheet 315a together with the label image, the die cutting apparatus including the eye mark detection sensor 312 performs the following operation upon detection of the eye mark by the eye mark detection sensor 312. The die cutting apparatus adjusts the label image print position and the die cutting position based on the position of the detected eye mark, depending on the conveyance amount of the print medium 315 read by the conveyance distance detection sensor 314, and the die cutting blade 501a is pressed against the print medium 315. The die cutting blade 501a is a blade with such a depth that the die cutting blade 501a cuts only the label sheet 315a in the upper layer, and does not trim the mount 315b in the lower layer. In the die cutting unit 313 illustrated in FIG. 5, the die cutting blade sheet 501b can be attached and detached, and the shape or size of the die cutting blade 501a can be changed by replacing the die cutting blade sheet 501b. Since the die cutting is performed based on the eye mark in the flat die cutting method, the die cutting blade can be manufactured without consideration on the paper feeding amount.

In the die cutting apparatus using the flat die cutting method and including the eye mark detection sensor and the conveyance distance detection sensor, the repeated operation length of the die cutting apparatus can be controlled based on the eye mark position as long as the eye mark is printed on the label sheet together with the label image. Accordingly, a desired die-cut label can be obtained in a case where the eye mark is printed on the label sheet together with the label image. However, the desired die-cut label cannot be obtained in a case where the eye mark is not printed on the label sheet together with the label image.

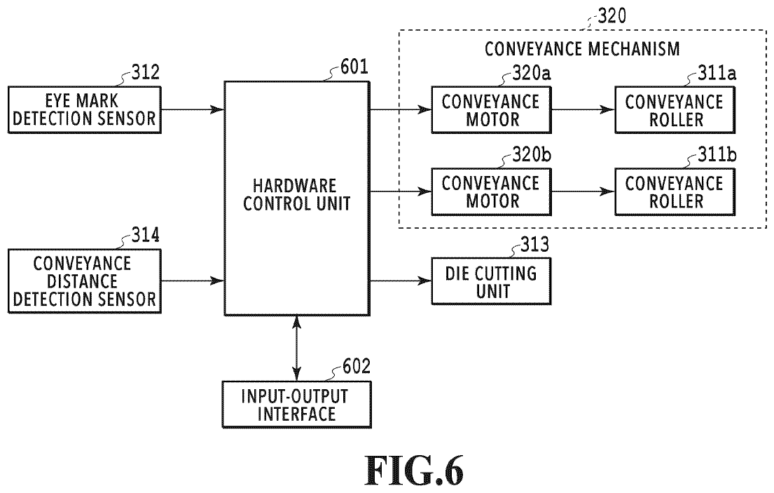

FIG. 6 is a block diagram illustrating a control system of the die cutting apparatus 131 using the flat die cutting method. A hardware control unit 601 is connected to the eye mark detection sensor 312, the die cutting unit 313, the conveyance distance detection sensor 314, a conveyance mechanism 320, and an input-output interface 602. The conveyance mechanism 320 includes the conveyance rollers 311a and 311b and conveyance motors 320a and 320b that drive the conveyance rollers 311a and 311b, respectively. The die cutting unit 313 includes a drive mechanism that drives the die cutting roller 401, the anvil roller 402, and the die 501. The control system of the die cutting apparatus 131 using the rotary method does not include the eye mark detection sensor 312, the conveyance distance detection sensor 314, or the drive mechanism that drives the die 501. Instead, the control system requires a drive mechanism that drives the die cutting roller 401 and the anvil roller 402.

The hardware control unit 601 controls the conveyance mechanism 320 and the die cutting unit 313 to achieve the above-mentioned die cutting operation. The die-cut label is generated from the print medium 315 by this control. The input-output interface 602 is connected to the input-output interface 116 of the host computer 101. The die cutting apparatus 131 can cause the hardware control unit 601 to transmit characteristic information of the die cutting unit 313 via the input-output interface 602, in response to a request from the host computer 101. Moreover, in a case where the die cutting unit 313 uses a laser cut method, the input-output interface 602 may be configured to receive the cut line layer data used to form cut portions from the host computer 101.

### Software Configuration of Label Creation System

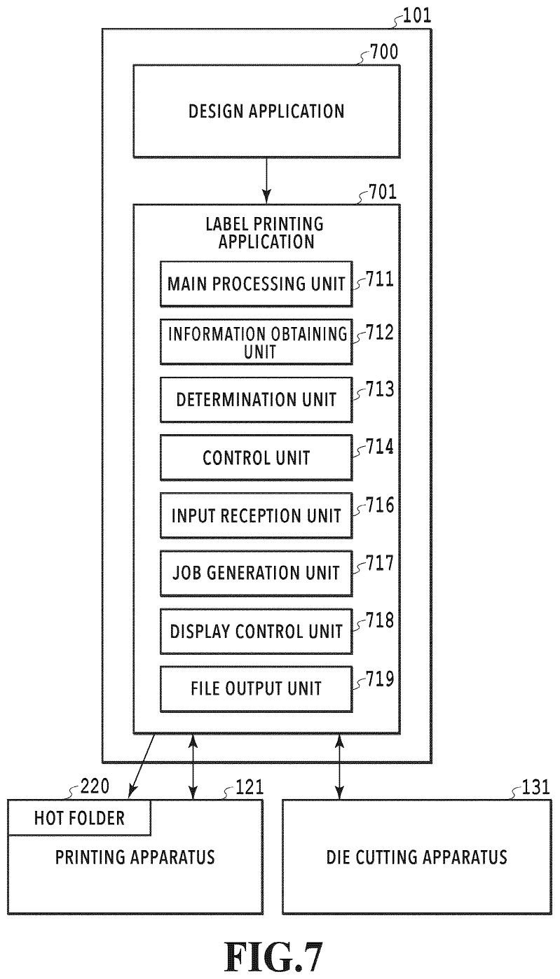

FIG. 7 is a diagram schematically illustrating a software configuration of the label creation system. The software of the label creation system includes a design application 700 and a label printing application 701. The design application 700 is an application that operates on the host computer 101 and creates the label data. A user who creates and edits the label data creates the label data to be printed by the printing apparatus 121, on the design application 700. The design application 700 can create design data with a layered structure.

Layers are virtual layers of the print data to which individual elements belong, and can be identified from one another by colors of the elements or uniquely-assigned layer identifiers in a display on the application. The user can select each layer as a printing target layer or a non-printing target layer. In the label creation step, in creation of the label data, the user can include the cut line, indicating the position of die cutting in the step after the printing, over the non-printing target layer as the cut line layer data.

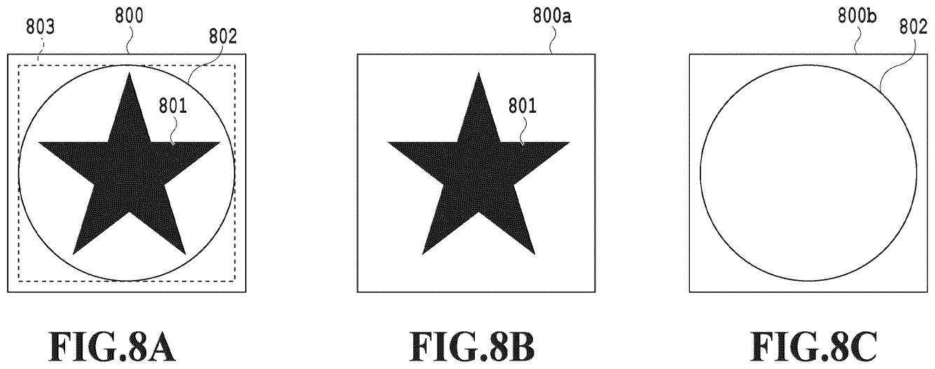

FIGS. 8A, 8B, and 8C are diagrams schematically illustrating the label data created with the design application 700. As illustrated in FIG. 8A, the label data 800 includes a print object 801 and a cut line object 802. Moreover, a rectangle 803 illustrates a finish size of the label. A region between an outer shape rectangle of the label data 800 and the rectangle 803 illustrating the finish size is an additional paint region. As illustrated in FIG. 8B, a layer 800a is a printing target layer of the label data 800, and the print object 801 to be printed is included in this layer. Moreover, a layer identifier of “print label” is assumed to be assigned to the printing target layer 800a. In this example, the layer identifier is used to identify a layer name in an application that can interpret the label data created by the design application 700. As illustrated in FIG. 8C, a layer 800b is a non-printing target layer of the label data 800, and the cut line object 802 not to be printed is included in this layer. Moreover, a layer identifier of “cut line” is assumed to be assigned to the non-printing target layer 800b. Although Portable Document Format (PDF) is assumed to be used as the file format of the label data in the present embodiment, the file format is not limited to this. Moreover, in the PDF file, the layer identifier is assumed to be included in an optional content properties (OC properties) dictionary of a PDF structure.

The label printing application 701 operates on the host computer 101, can interpret the label data 800 created by the design application 700, and creates the print job for performing printing in the printing apparatus 121 from the label data 800. The label printing application 701 includes a main processing unit 711, an information obtaining unit 712, a determination unit 713, a control unit 714, a warning unit 715, an input reception unit 716, a job generation unit 717, a display control unit 718, and a file output unit 719.

The main processing unit 711 executes functions of processing of the label printing application 701 in general such as processing of generating various windows and processing of performing various types of determination. The information obtaining unit 712 obtains information on a print region of the printing apparatus 121 (print region information) and operation characteristic information of the die cutting apparatus 131. The determination unit 713 determines the cut line layer data to be used in the die cutting apparatus 131, from the print region information and the operation characteristic information obtained by the information obtaining unit 712. The control unit 714 separates the cut line layer data determined by the determination unit 713, from the print data. Moreover, in a case where the user accepts a warning issued in a case where an eye mark reading device (identification mark reading device) is present and the print data includes no eye mark layer data (identification mark layer data), the control unit 714 performs the following operation. The control unit 714 adds the eye mark layer data (identification mark layer data) to the print data. The warning unit 715 instructs the display control unit 718 to display a warning message window or the like in a case where the user needs to be warned in determination of the cut line layer data in the determination unit 713. The input reception unit 716 receives a user input in an input region of a window displayed on the display device 119. The job generation unit generates the print job. The generated job is transmitted to a hot folder 220 of the printing apparatus 121, and is saved in the designated hot folder 220. The display control unit 718 displays the warning message window, a window generated by the main processing unit 711, and the like on the display device 119. The file output unit 719 outputs the cut line layer data, layer data including the cut line layer data and the eye mark layer data, or the like to a file.

The printing apparatus 121 provides the hot folder 220 as means for receiving the print job, and the label printing application 701 inputs the created print job into the hot folder 220 of the printing apparatus 121. In a case where the print job of the label data is inputted into the hot folder 220, the printing apparatus 121 performs a print request to the print engine 214 based on print setting information set in advance, and the label data is printed on the print medium 315. The print medium 315 on which the label data is printed is supplied to a conveyance unit of the die cutting apparatus 131, and is die-cut by the die cutting unit 313, and the die-cut label is produced.

### Processing of Saving Print Job

Explanation is given of processing of generating cut line layer data necessary to create a blade die to be used by the die cutting unit 313 of the die cutting apparatus 131, in creation of the print job in the label printing application 701. In the present embodiment, two pieces of label data 800 are aligned in a horizontal direction and 500 pieces of label data 800 are aligned in a vertical direction on a print medium with a width of 180 mm. The labels die-cut by the die cutting apparatus such that an interval between the adjacent labels is 30 mm and an interval between the upper label and the lower label is 20 mm are assumed to be produced.

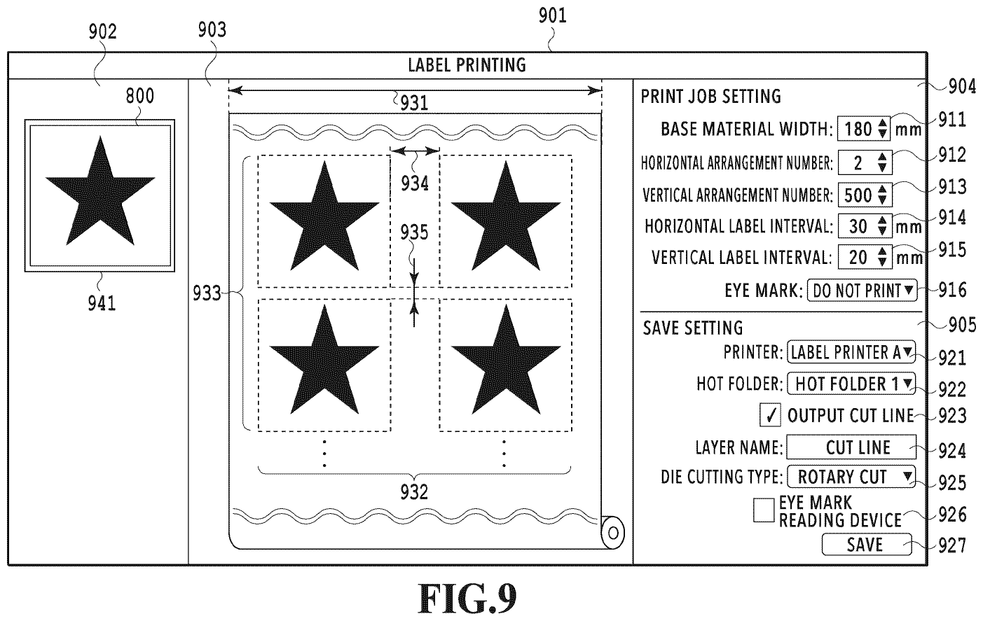

FIG. 9 is an example of a screen of the label printing application 701. A window 901 is an application window in a state where the label data 800 is read. The window 901 includes a label data selection portion 902, a preview portion 903, a print job setting portion 904, and a save setting portion 905. The label data selection portion 902 is a region in which the read label data is displayed in a thumbnail list format and the label data to be printed is selected. In this example, the label data 800 is assumed to be selected by using a selection frame 941. The preview portion 903 is a region displaying a layout in which the label data is to be printed on the print medium 315 in the printing apparatus 121, based on settings in the print job setting portion 904.

The following settings are made in the print job setting portion 904 to generate the above-mentioned labels. In order to perform printing on the print medium with the width of 180 mm, “180 mm” is set in a base material width 911, and 931 in the preview portion 903 becomes a display corresponding to this setting. Arrangement of the label data is performed based on the above-mentioned finish size of the label data 800. First, since two pieces of label data 800 are aligned in the horizontal direction, “2” is set in a horizontal arrangement number 912, and 932 of the preview portion 903 becomes a display corresponding to this setting. Moreover, since 500 pieces of label data 800 are aligned in the vertical direction, “500” is set in a vertical arrangement number 913, and vertical arrangement 933 of the preview portion 903 becomes a display corresponding to this setting. The display of the labels aligned in the vertical direction only needs to be a display that allows the user to visually confirm that the designated number of pieces of label data are aligned in the vertical direction, such as a display with a scroll bar. Next, since the interval between the adjacent labels is 30 mm, “30 mm” is set in a horizontal label interval 914, and a horizontal label interval 934 of the preview portion 903 becomes a display corresponding to this setting. Moreover, since the interval between the upper and lower labels is 20 mm, “20 mm” is set in a vertical label interval 915, and a vertical label interval 935 of the preview portion 903 becomes a display corresponding to this setting. In an eye mark setting 916, it is possible to select “perform printing in units of labels” in which the eye mark is printed in units of labels or “perform printing in units of pages” in which the eye mark is printed in units of pages.

The following settings are made in the save setting portion 905 to save the print job of the labels described above. In an output printer 921, “label printer A” is set to designate the printing apparatus 121 to perform the printing. The label printer A is connected to the host computer 101. In an output hot folder 922, a list of hot folders 220 that are provided by the printing apparatus 121 and for which the print settings are registered in advance is displayed, and a “hot folder 1” being one of the hot folders 220 is set. A cut line output selection 923 is a region for selecting whether or not the cut line is to be outputted. In a case where the cut line output selection 923 is in a selected state, a cut line layer name 924 and a die cutting type 925 below the cut line output selection 923 become selectable. In a case where the cut line output selection 923 is in a not-selected state, the cut line layer name 924 and the die cutting type 925 cannot be selected. Moreover, in a case where the cut line output selection 923 is in the selected state, the cut line layer data included in the label data 800 is outputted as another file in output of the print job to the hot folder 1. Although the print job is outputted as the PDF file in the present embodiment, the print job may be outputted in any file format that can be interpreted by the printing apparatus 121. Moreover, although the cut line layer data is also outputted as the PDF file in the present embodiment, the cut line layer data is not limited to this. The file of the cut line layer data may be any file format used to create the die cutting blade such as a file format used in computer aided design (CAD) software.

In the present embodiment, the cut line output selection 923 is assumed to be in the selected state. In the cut line layer name 924, the layer identifier of the cut line object included in the label data 800 is designated. In this example, the layer identifier of “cut line” of the layer 800b is assumed to be designated. In the die cutting type 925, the die cutting method of the die cutting apparatus 131 that die-cuts the print medium on which the label data is printed is designated. In this example, the die cutting method of the die cutting apparatus 131 connected to the host computer 101 is designated. It is possible to select “rotary cutting” or “flat die cutting” as the designated die cutting method. In a case where the flat die cutting is set selected in the die cutting type 925, an eye mark reading device 926 becomes selectable. In a case where the die cutting apparatus 131 includes the eye mark reading device, a selected state is designated. In a case where the die cutting apparatus 131 does not include the eye mark reading device, a not-selected state is designated.

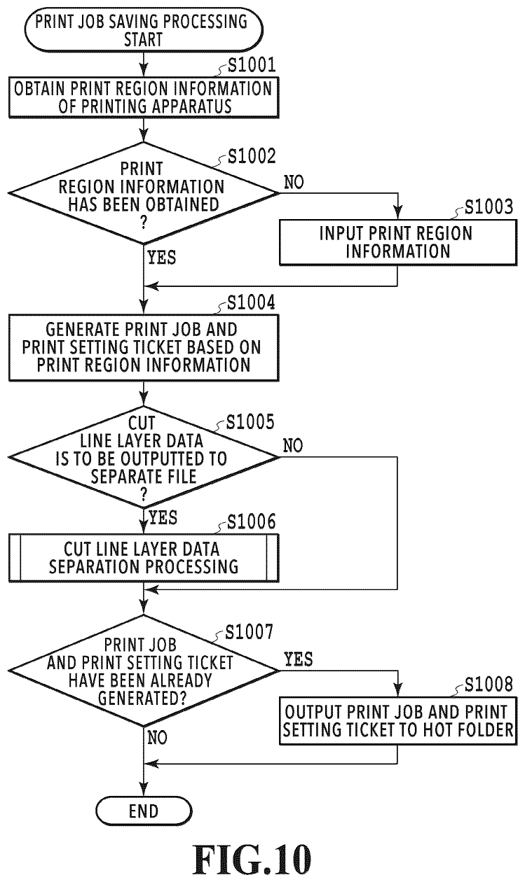

A button 927 is a save button. In a case where the button 927 is pressed, the CPU 111 of the host computer 101 executes print job saving processing in the flowchart illustrated in FIG. 10 through the label printing application 701. Specifically, the processing of the flowchart illustrated in FIG. 10 is started in a case where the user saves the print job in which the label data is arranged. Details of the processing of the flowchart illustrated in FIG. 10 are explained as follows.

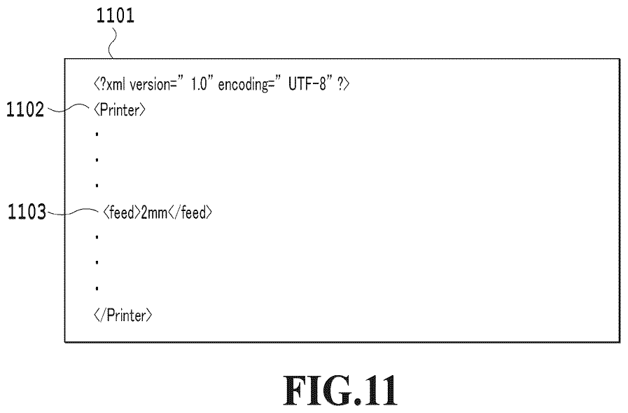

In S1001, the CPU 111 obtains the print region information of the printing apparatus 121 (output printer) through the information obtaining unit 712. The processing proceeds to S1002 in a case where the print region information of the printing apparatus 121 (output printer) is obtained. FIG. 11 is a diagram schematically illustrating an example of the print region information obtained from the label printer A set in the output printer 921. Although XML format information 1101 in which the label printing application 701 has recorded the print region information of the label printer A in advance is assumed to be obtained in this example, the print region information is not limited to this. The host computer 101 may communicate with the printing apparatus 121, and obtain the print region information. Moreover, a data format of the print region information is also not limited to the XML format. The data format of the print region information may be any format that can be interpreted by the label printing application 701 such as a job definition format (JDF) widely used in commercial printing. A Printer element 1102 is an element including print region characteristics of the label printer A. A feed element 1103 is an element included in the Printer element 1102, and illustrates that 2 mm is set as the value of this element. In the feed element 1103, the paper feeding amount is designated as one of the print region characteristics of the label printer A. The example of FIG. 11 indicates that the print medium 315 is fed 2 mm after the printing of the print data of one page included in the print job.

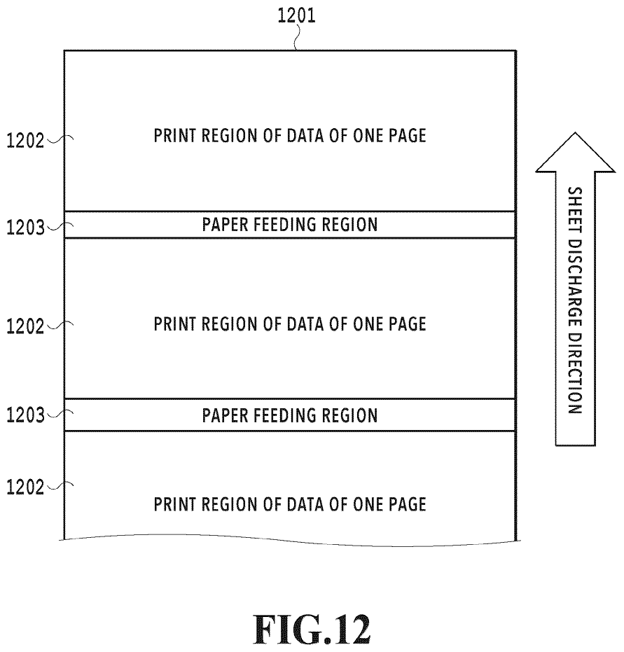

FIG. 12 is a diagram schematically illustrating the print data and the paper feeding amount in the inter-page printing in a case where printing is performed in the label printer A. A region 1201 illustrates the print medium 315. Each of regions 1202 is a region in which job data of one page is printed, and is a region in which two pieces of label data 800 are arranged in the horizontal direction and one piece of label data 800 is arranged in the vertical direction. After printing the job data of one page, the label printer A conveys the print medium 315 by 2 mm in a sheet discharge direction as illustrated in each of regions 1203. Then, the label printer A repeats the operation of printing the job data of the next one page and conveying the print medium 315 by 2 mm in the sheet discharge direction.

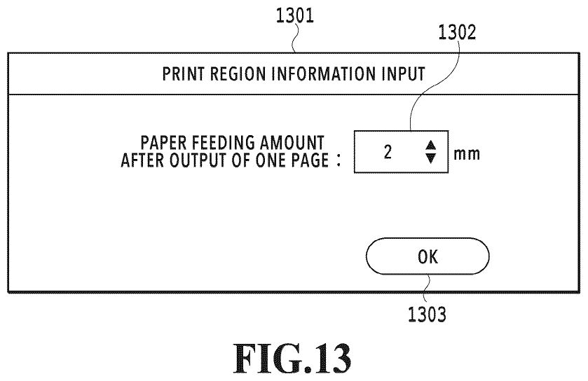

In S1002, the CPU 111 determines whether or not the print region information has been obtained in S1001, through the main processing unit 711. In a case where the print region information has been obtained, the processing proceeds to S1004. For example, in a case where the print region information has not been obtained due to a state where the host computer 101 and the printing apparatus 121 cannot communicate with each other or the like, the processing proceeds to S1003. In S1003, the CPU 111 displays an input screen 1301 of the print region information illustrated in FIG. 13, and receives an input of the print region information from the user, through the main processing unit 711 and the input reception unit 716. The input screen 1301 of the print region information is an example of an input screen of the print region information. The input screen 1301 of the print region information includes a paper feeding amount 1302 and an input finalization button 1303. The user inputs the amount by which the print medium 315 is to be conveyed in the sheet discharge direction after the output of the print data of one page by the output printer, in the paper feeding amount 1302 by referring to a user guide of the printing apparatus 121 or the like. In a case where the user presses the input finalization button 1303, the processing proceeds to S1004.

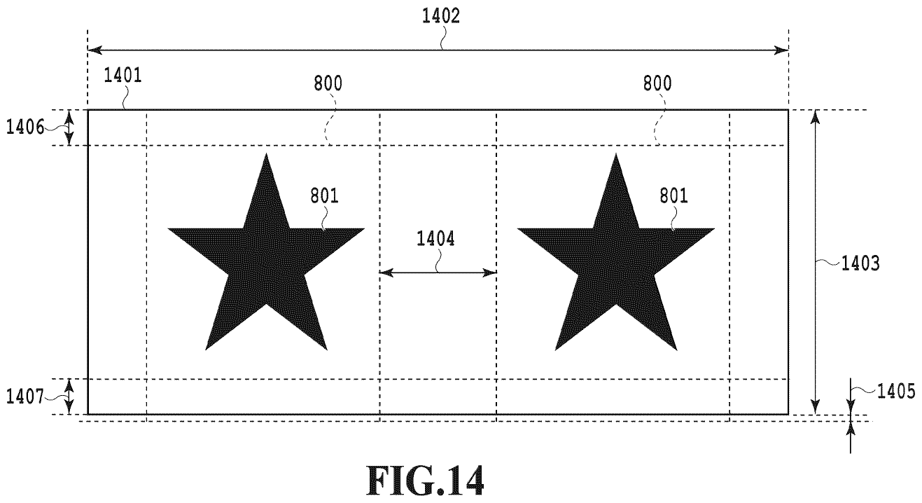

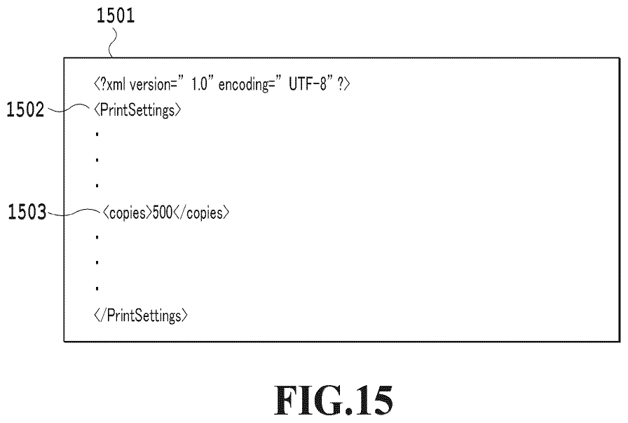

In S1004, the CPU 111 generates the print job and a print setting ticket based on the print region information obtained in S1001, through the main processing unit 711 and the job generation unit 717. In this case, the print job illustrated in FIG. 14 and the print setting ticket illustrated FIG. 15 are generated. FIG. 14 is a diagram schematically illustrating the print job. The setting described below is performed as the print job based on the settings of the print job setting portion 904 and the print region information obtained in S1001. A sheet width 1402 is set to 180 mm, and a sheet height 1403 is set to 78 mm. Two pieces of label data 800 are arranged in the horizontal direction, and a horizontal label interval 1404 is set to 30 mm. Regarding the arrangement of the labels, the print object 801 with the layer identifier of “print label” that is to be printed is arranged based on a finish size reference. A paper feeding amount 1405 that is the print region information is set to 2 mm. A margin 1406 at a label top is set to 9 mm, and a margin 1407 at a label bottom is set to 9 mm in consideration of the paper feeding amount 1405. The interval between the upper and lower labels in a case where the labels are continuously printed is 20 mm, in consideration of the paper feeding amount. Specifically, the margin at the top and the margin at the bottom are determined such that the label interval in the vertical direction becomes the same as the vertical label interval 915 (20 mm) designated in the print job setting portion 904, in consideration of the paper feeding amount of 2 mm that is the print region information. The paper feeding amount of 2 mm is subtracted from the vertical label interval of 20 mm, and the remaining 18 mm is distributed as the margins at the top and the bottom. In this example, the margin at the top is set to 9 mm, and the margin at the bottom is also set to 9 mm. This causes the sum of the margin at the label bottom, the paper feeding amount, and the margin at the label top to be 20 mm which is designated in the vertical label interval 915. Moreover, the arrangement number in the vertical direction is 500, and is the number of copies to be continuously printed. The print setting ticket designating the number of copies to be printed is generated based on the arrangement number in the vertical direction.

FIG. 15 is a diagram schematically illustrating the print setting ticket designating the number of copies to be printed. The contents of the print setting ticket 1501 is included in information of XML format. A value of 500 is set in a copies element 1503 that is included in a PrintSettings element 1502 indicating the print settings and that corresponds to the number of copies to be printed. The format of the print setting ticket is not limited to the XML format, and may be any format that can be interpreted by the printing apparatus 121 such as the JDF format. In a case where the print job and the print setting ticket are generated, the processing proceeds to S1005.

In S1005, the CPU 111 determines whether or not the cut line layer data is to be outputted to another file, through the main processing unit 711. This determination is performed depending on whether or not the cut line output selection 923 is checked. Specifically, in a case where the cut line output selection 923 is checked, the cut line layer data is outputted to another file. In a case where the cut line output selection 923 is not checked, the cut line layer data is not outputted to another file. In a case where the CPU 111 determines to output the cut line layer data to another file, the processing proceeds to S1006. In a case where the CPU 111 determines not to output the cut line layer data to another file, the processing proceeds to S1007.

### Cut Line Layer Data Separation Processing

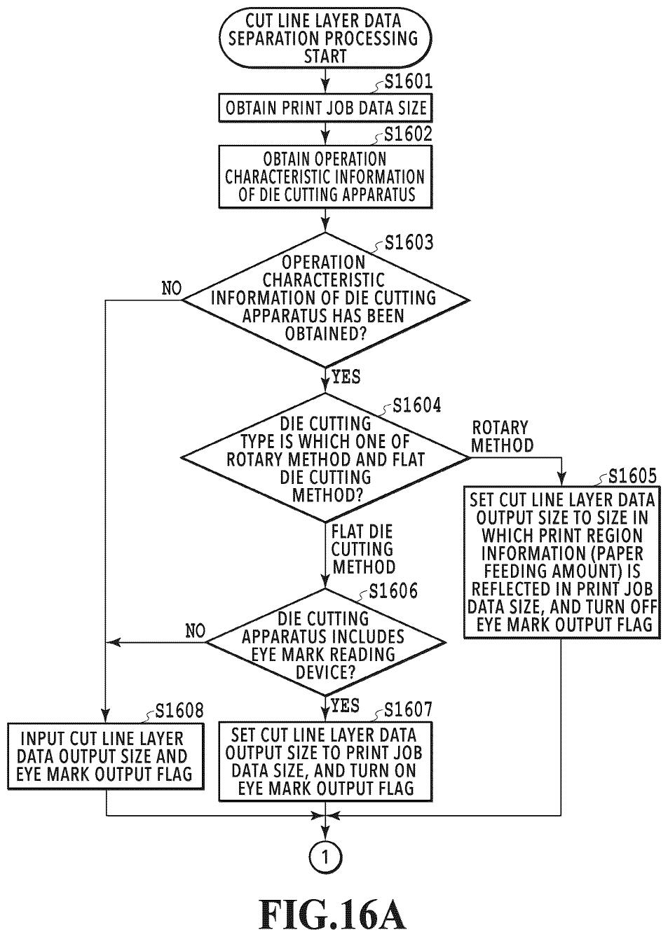

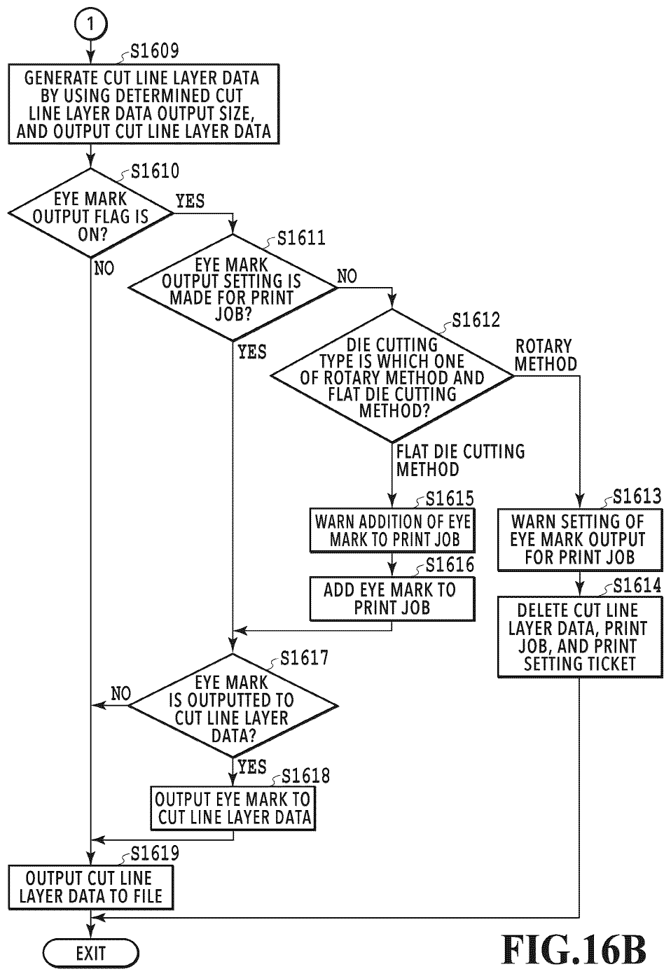

In S1006, the CPU 111 executes cut line layer data separation processing illustrated in the flowcharts of FIGS. 16A and 16B, through the label printing application 701. The cut line layer data separation processing is processing of separating the cut line layer data from the print data and outputting a file. In S1601, the CPU 111 obtains a print job data size included in the print job, through the information obtaining unit 712 and the job generation unit 717. Moreover, the paper feeding amount included in the print region information has been obtained in the process of S1001 or S1002. In a case where the process relating to obtaining of the print job data size is completed, the processing proceeds to S1602.

In S1602, the CPU 111 obtains the operation characteristic information of the die cutting apparatus 131 through the information obtaining unit 712. The operation characteristic information of the die cutting apparatus 131 includes information such as the die cutting type 925 of the die cutting apparatus 131 and presence or absence of the eye mark reading device 926. The host computer 101 may communicate with the die cutting apparatus 131 to obtain the operation characteristic information of the die cutting apparatus 131. In a state where the host computer 101 and the die cutting apparatus 131 cannot communicate with each other or the like, the process of S1602 is completed with the operation characteristic information of the die cutting apparatus 131 not obtained. In a case where the process of S1602 is completed, the processing proceeds to S1603.

In S1603, the CPU 111 determines whether or not the operation characteristic information of the die cutting apparatus 131 has been obtained, through the main processing unit 711. In a case where the operation characteristic information of the die cutting apparatus 131 has been obtained, the processing proceeds to S1604. In a case where the operation characteristic information of the die cutting apparatus 131 has not been obtained, the processing proceeds to S1608. In a state where the host computer 101 and the die cutting apparatus 131 cannot communicate with each other or the like, the operation characteristic information of the die cutting apparatus 131 cannot be obtained. In S1604, the CPU 111 determines the die cutting type of the die cutting apparatus 131 through the main processing unit 711. In a case where the die cutting type is the “rotary method”, the processing proceeds to S1605. In a case where the die cutting type is the “flat die cutting method”, the processing proceeds to S1606.

In S1605, the CPU 111 sets a cut line layer data output size to a size in which the paper feeding amount of the print region information is reflected in the print job data size, through the determination unit 713. As described above, since the repeated operation size is the blade die sheet size in the rotary cutting method, the size taking not only the print job data size but also the paper feeding amount of the printing apparatus 121 into consideration is the blade die sheet size. In the above-mentioned example, the width of the cut line layer data output size is 180 mm, which is the width of the print job size, and the height of the cut line layer data output size is 80 mm obtained by adding 2 mm, which is the paper feeding amount, to 78 mm, which is the height of the print job data size (sheet height). Moreover, in the rotary cutting method, since the eye mark output (identification mark output) is unnecessary, the CPU 111 turns off an eye mark output flag through the label printing application 701. In a case where the above settings are completed, the processing proceeds to S1609.

In S1606, the CPU 111 determines whether or not the die cutting apparatus 131 includes the eye mark reading device, through the main processing unit 711. In a case where the CPU 111 determines that the die cutting apparatus 131 includes the eye mark reading device, the processing proceeds to S1607. In a case where the CPU 111 determines that the die cutting apparatus 131 does not include the eye mark reading device, the processing proceeds to S1608. In S1607, the CPU 111 turns on the eye mark output flag through the main processing unit 711. The cut line layer data output size is set to the print job data size. In a case where the die cutting type is the flat die cutting method, since the die cutting apparatus 131 aligns the cut position to the eye mark position read by the eye mark detection sensor 312, the print region information does not have to be reflected in the output size of the cut line layer data. In a case where the above-mentioned setting is completed, the processing proceeds to S1609.

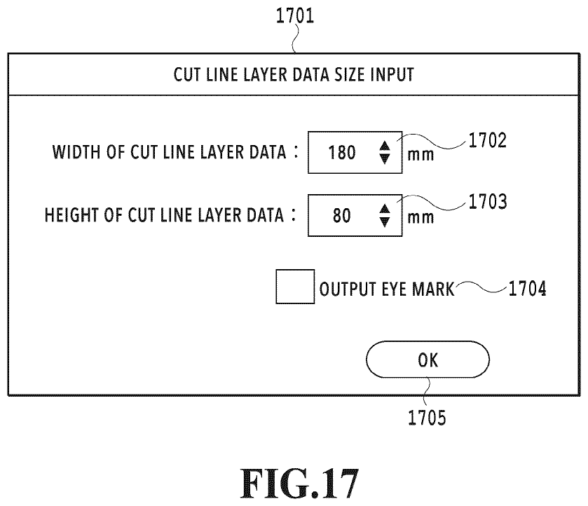

In S1608, the CPU 111 displays a cut line layer data size input screen illustrated in FIG. 17, through the main processing unit 711 and the input reception unit 716, and the user inputs the cut line layer data output size and an eye mark output method. In a case where the die cutting type of the die cutting apparatus 131 is unknown or the die cutting apparatus 131 using the flat die cutting method does not include the eye mark reading device, the process of S1605 or the process of S1607 is not executed. Accordingly, the processes of designating the output size of the cut line layer data and the presence or absence of the eye mark output are not executed. Thus, the output size of the cut line layer data and the eye mark output method are designated by a user input, and the cut line layer data is created.

A screen 1701 is an example of the cut line layer data size input screen. The screen 1701 includes a width 1702 of the cut line layer data, a height 1703 of the cut line layer data, an eye mark output 1704, and an input finalization button 1705. The cut line layer data is created based on the width 1702 of the cut line layer data and the height 1703 of the cut line layer data inputted by the user. In a case where the eye mark output 1704 is in a selected state, the eye mark is outputted to the cut line layer data. In a case where the eye mark output 1704 is in a not-selected state, the eye mark is not outputted to the cut line layer data. In a case where the input finalization button 1705 is pressed, the processing proceeds to S1609.

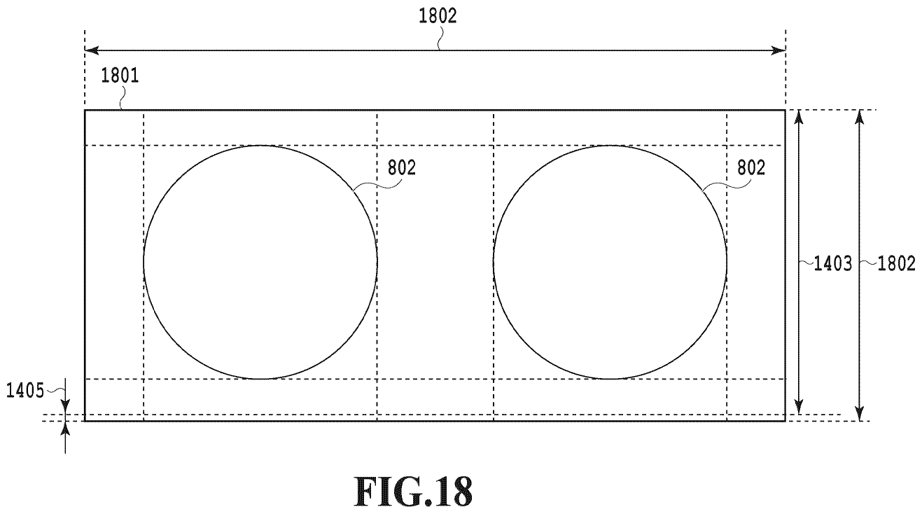

In S1609, the CPU 111 determines the cut line layer data by using the determined cut line layer data output size, and separates the cut line layer data from the print data, through the determination unit 713 and the control unit 714. FIG. 18 is an example of a diagram schematically illustrating the separated cut line layer data. The example illustrated in FIG. 18 is the cut line layer data generated based on the cut line layer data output size for the rotary method determined in S1605. A width 1802 of the output size of the cut line layer data 1801 is 180 mm, which is the sheet width 1402 of the print job data. A height 1803 of the output size of the cut line layer data 1801 is 80 mm obtained by adding the paper feeding amount 1405 (2 mm), which is the print region information, to the height 1403 of the print job data. Two cut line objects 802 with the layer identifier of “cut line” in the label data 800 are arranged in the horizontal direction at the same positions as finish size reference positions where the print objects 801 in the print job data are arranged. In a case where the processing proceeds to S1609 after execution of S1608, the width 1802 and the height 1803 of the cut line layer data 1801 are set to the width 1702 and the height 1703 of the cut line layer data that are the values inputted in S1608. In a case where the generation and output of the cut line layer data are completed, the processing proceeds to S1610.

In S1610, the CPU 111 determines whether or not the eye mark output flag is on, through the main processing unit 711. In a case where the eye mark output flag is on, the processing proceeds to S1611. In a case where the eye mark output flag is off, the processing proceeds to S1619. In S1611, the CPU 111 determines whether or not the eye mark output setting is made for the print job, through the main processing unit 711. In a case where the “perform printing” is set in the eye mark setting 916, the processing proceeds to S1615. In a case where the “perform no printing” is set in the eye mark setting 916, the processing proceeds to S1612. In S1612, the CPU 111 determines whether the die cutting type is the rotary method or the flat die cutting method, through the main processing unit 711. In a case where the die cutting type is the rotary method, the processing proceeds to S1613. In a case where the die cutting type is the flat die cutting method, the processing proceeds to S1615.

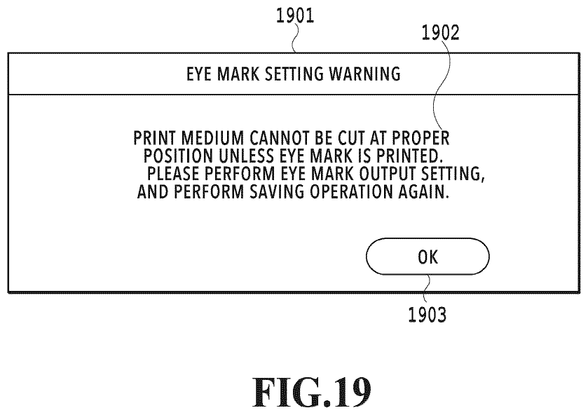

In S1613, the CPU 111 displays an eye mark setting warning screen 1901 illustrated in FIG. 19, through the main processing unit 711, the warning unit 715, and the display control unit 718. The eye mark setting warning screen 1901 is an example, and a display of another type may be used. The eye mark setting warning screen 1901 includes a warning message 1902 and a confirmation button 1903. In a case where the CPU 111 detects pressing of the confirmation button 1903 through the display control unit 718, the processing proceeds to S1614. In S1614, the CPU 111 deletes the cut line layer data generated in S1609 and the print job and the print setting ticket generated in S1004, through the main processing unit 711. In a case where the above-mentioned deletion is completed, the processing flow of the flowcharts illustrated in FIGS. 16A and 16B is finished, and the processing proceeds to S1007 illustrated in FIG. 10.

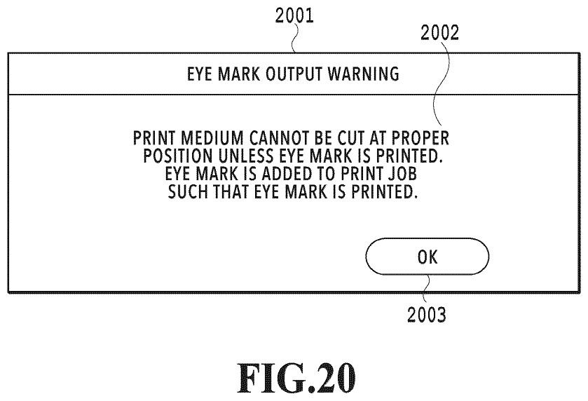

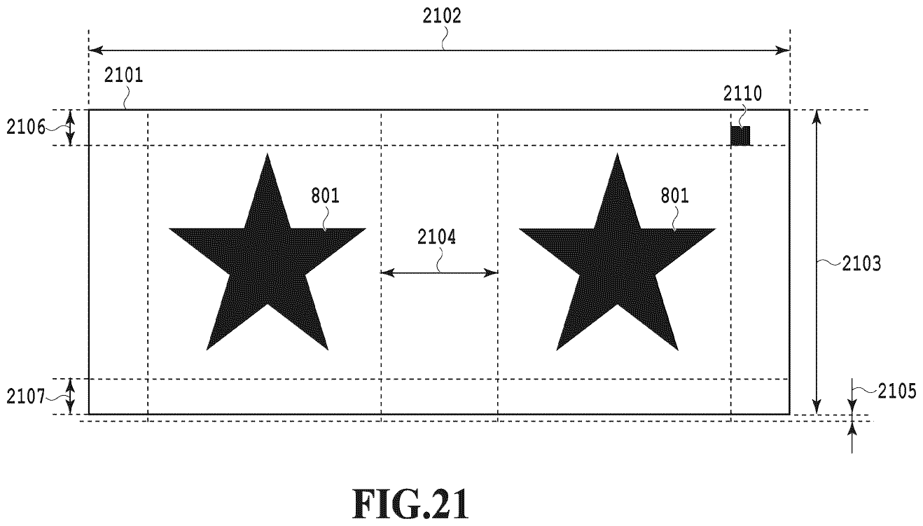

In S1615, the CPU 111 displays an eye mark output warning screen 2001 illustrated in FIG. 20, through the main processing unit 711, the warning unit 715, and the display control unit 718. The eye mark output warning screen 2001 is an example, and a display of another type may be used. The eye mark output warning screen 2001 includes a warning message 2002 and a confirmation button 2003. In a case where the CPU 111 detects pressing of the confirmation button 2003 through the display control unit 718, the processing proceeds to S1616. In S1616, the CPU 111 adds the eye mark layer data to the print data in the print job generated in S1004, and updates the contents of the print job, through the main processing unit 711, the control unit 714, and the job generation unit 717. In a case where the eye mark layer data is added to the print data in the print job, the processing proceeds to S1617. This means a process as follows: the eye mark object is added to the print job 1401 to which the eye mark object is not outputted as illustrated in FIG. 14, and the print job 1401 is updated to a print job 2101 as illustrated in FIG. 21.

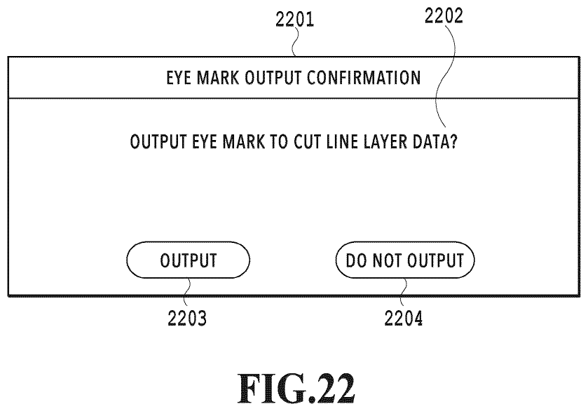

In S1617, the CPU 111 displays an eye mark output confirmation screen 2201 illustrated in FIG. 22, through the main processing unit 711 and the display control unit 718. The eye mark output confirmation screen 2201 is an example, and a display of another type may be used. The eye mark output confirmation screen 2201 includes a confirmation message 2202, an “output” button 2203, and a “do not output” button 2204. In a case where the “output” button 2203 is pressed, the processing proceeds to S1618. In a case where the “do not output” button 2204 is pressed, the processing proceeds to S1619. In a case where the die cutting type is the flat die cutting method and the eye mark position is adjusted after die cutting blade creation, an adjustment operation can be efficiently performed by outputting the eye mark such that the eye mark is aligned with the cut line layer data.

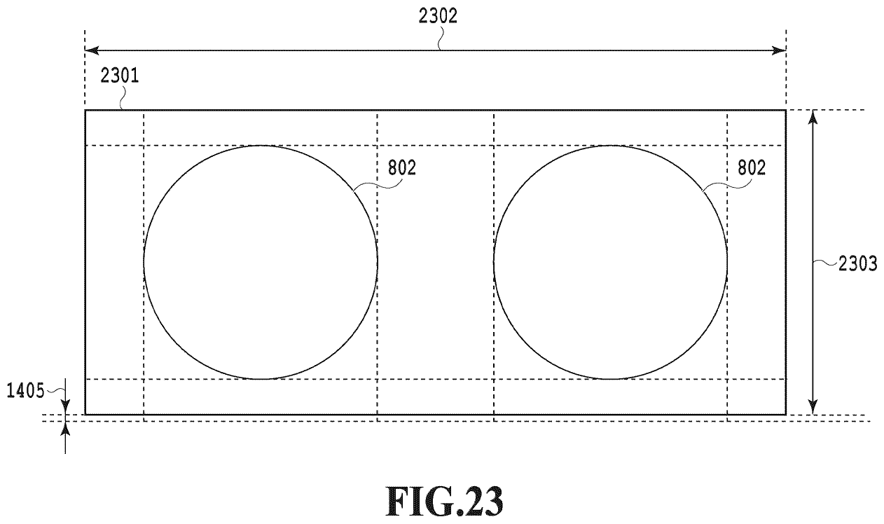

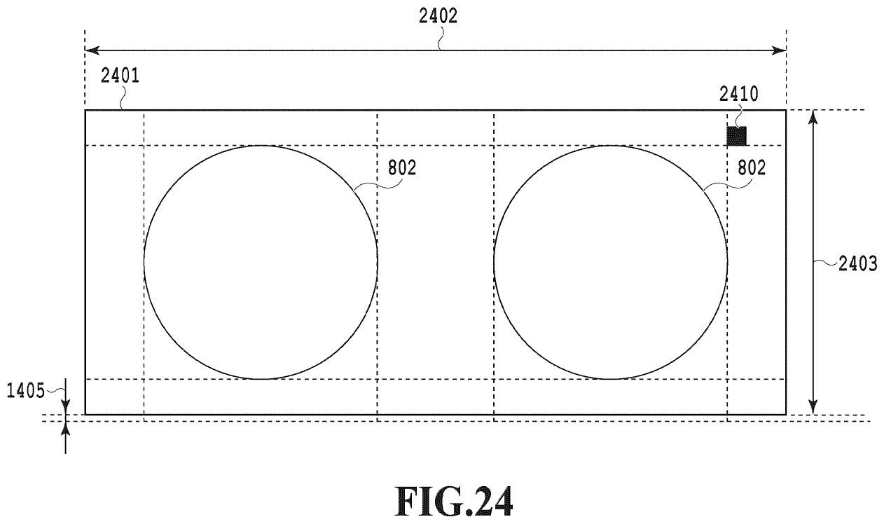

In S1618, the CPU 111 performs the following process through the main processing unit 711. The CPU 111 performs a process of updating the cut line layer data by arranging an eye mark object 2110 of the print job 2101, at the same coordinates as those in the print job data, in cut line layer data 2301 illustrated in FIG. 23. The cut line layer data 2301 illustrated in FIG. 23 is an example of the flat die cutting method not taking the paper feeding amount into consideration. FIG. 24 is an example of the cut line layer data to which the eye mark is outputted. The cut line layer data 2401 has a configuration in which an eye mark object 2410 is added to the cut line layer data 2301 to which no eye mark object is outputted. In a case where the eye mark object is added to the cut line layer data, the processing proceeds to S1619.

In S1619, the CPU 111 outputs the generated cut line layer data to a file through the file output unit 719. A folder to be outputted to the file may be a folder registered in advance by the user to output the cut line layer data or any folder designated by the user in saving. In a case where the cut line layer data is outputted to the file, the processing flow of the flowcharts illustrated in FIGS. 16A and 16B is finished, and the processing proceeds to S1007 illustrated in FIG. 10.

Note that, in a case where the die cutting apparatus 131 using the flat die cutting method does not include the eye mark reading device (in a case where NO is selected in S1606), the die cutting apparatus 131 cannot read the eye mark even if the eye mark is printed on the print medium. In this case, a length obtained by adding the paper feeding amount obtained in S1001 or S1002 to the height of the print job data obtained in S1601 is used as a conveyance unit in die cutting. The die cutting apparatus 131 conveys the print medium based on this conveyance unit in die cutting, and die-cuts the print medium. This allows die cutting desired by the user to be performed. The length obtained by adding the paper feeding amount to the height of the print job data is used as the conveyance unit, instead of the height of the print job data, also in the die cutting apparatus 131 using the flat die cutting method and not including the eye mark reading device.

### Processing of Outputting Print Job and Print Setting Ticket

Returning to the flowchart of FIG. 10, in S1007, the CPU 111 determines whether or not the print job and the print setting ticket have been already generated, through the main processing unit 711 and the job generation unit 717. In a case where the CPU 111 determines that the print job and the print setting ticket have been already generated, the processing proceeds to S1008. In a case where the CPU 111 determines that the print job or the print setting ticket has not been generated, the processing flow of the flowchart illustrated in FIG. 10 is finished. In S1008, the CPU 111 outputs the generated print job and print setting ticket to the “hot folder 1” designated in the output hot folder 922, through the job generation unit 717. In a case where this process is completed, the processing flow of the flowchart illustrated in FIG. 10 is finished.

In a case where the print job and the print setting ticket in which the contents corresponding to the number of copies to be printed are described are outputted to the hot folder 1, the label printer A adds the print job to the print settings set in advance, and performs printing of the number of copies described in the ticket on print media. In the above-mentioned example, data of one page of the print job is continuously printed 500 times on the print media. The blade die of the rotary die cutting sheet is created from the cut line layer data outputted in S1619. The die cutting apparatus 131 to which the created die cutting sheet is attached die-cuts the print media to which the label data is printed, and die-cut labels are produced.

As described above, according to the present embodiment, it is possible to provide the cut line suitable for the printed product in the die cut forming step after the printing. Moreover, the die-cut labels can be efficiently obtained without an effect of a step (processing) after the printing.

In the present embodiment, the label printing application obtains the presence or absence of the eye mark reading device as the operation characteristic information of the die cutting apparatus. In a case where the eye mark reading device is present and the print data includes the eye mark layer data, the cut line layer data is separated along with the eye mark layer data from the print data, and the cut line layer data to be used in the die cutting apparatus is created. The operation of adjusting the eye mark position can be thereby efficiently performed after the creation of the blade die used in the die cutting apparatus.

In the present embodiment, the label printing application obtains the presence or absence of the eye mark reading device as the operation characteristic information of the die cutting apparatus. In a case where the eye mark reading device is present and the print data does not include the eye mark layer data, the warning is given, and the eye mark data is outputted to the print data. Occurrence of a situation where the eye mark is not printed on the print medium and the die cutting cannot be performed at a precise cut position can be thereby reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-139879, filed Aug. 30, 2023, which is hereby incorporated by reference wherein in its entirety.

What is claimed is:

1. An information processing apparatus configured to edit print data including cut line layer data used in die cutting of a printed medium, the information processing apparatus comprising one or more processors and/or circuitry which function as:
an obtaining unit configured to obtain print region information, including at least a paper feeding amount in inter-page printing, from a printing apparatus configured to perform the printing on the print medium and obtain operation characteristic information of a die cutting apparatus from the die cutting apparatus; and
a determination unit configured to determine the cut line layer data based on the print region information and the operation characteristic information.

2. The information processing apparatus according to claim 1, wherein the one or more processors and/or circuitry further function as a control unit configured to separate the cut line layer data, determined by the determination unit, from the print data.

3. The information processing apparatus according to claim 2, wherein the one or more processors and/or circuitry further function as an output unit configured to output the cut line layer data, which is separated by the control unit, to a file.

4. The information processing apparatus according to claim 3, wherein
the print region information further includes information indicating a height of a size of one page set by a print job, and
the determination unit determines the cut line layer data based on the information indicating the height of the size of one page, the paper feeding amount, and the operation characteristic information.

5. The information processing apparatus according to claim 4, wherein the operation characteristic information of the die cutting apparatus obtained by the obtaining unit includes information on a die cutting type or an identification mark reading device configured to read an identification mark indicating a position where the die cutting is to be performed.

6. The information processing apparatus according to claim 5, wherein, in a case where the operation characteristic information indicates that the die cutting type is a rotary method, the determination unit determines the cut line layer data by using the paper feeding amount and the information indicating the height of the size of one page obtained by the obtaining unit.

7. The information processing apparatus according to claim 5, wherein, in a case where the operation characteristic information indicates that the die cutting type is a flat die cutting method, the determination unit determines the cut line layer data by using the information indicating the height of the size of one page obtained by the obtaining unit.

8. The information processing apparatus according to claim 5, wherein, in a case where the operation characteristic information of the die cutting apparatus obtained by the obtaining unit includes information indicating presence of the identification mark reading device and the print data includes identification mark layer data including the identification mark, the control unit separates layer data obtained by combining the cut line layer data and the identification mark layer data included in the print data.

9. The information processing apparatus according to claim 8, wherein the output unit outputs the layer data, which is obtained by combining the cut line layer data and the identification mark layer data, to a file.

10. The information processing apparatus according to claim 5, wherein the one or more processors and/or circuitry further function as a display control unit configured to display a window on a display unit, wherein
in a case where the operation characteristic information of the die cutting apparatus obtained by the obtaining unit includes information indicating presence of the identification mark reading device and the print data does not include identification mark layer data including the identification mark indicating the position where the die cutting is to be performed, the display control unit displays a window, including a confirmation button and a warning message of including the identification mark layer data into the print data, on the display unit.

11. The information processing apparatus according to claim 10, wherein, in a case where: the operation characteristic information of the die cutting apparatus obtained by the obtaining unit includes the information indicating presence of the identification mark reading device; the print data does not include the identification mark layer data including the identification mark indicating the position where the die cutting is to be performed; and the display control unit detects pressing of the confirmation button displayed in the window, the control unit incorporates the identification mark layer data into the print data.

12. The information processing apparatus according to claim 5, wherein the one or more processors and/or circuitry further function as an input reception unit configured to receive user inputs on a size of the cut line layer data and whether or not to output the identification mark, wherein
in a case where the obtaining unit is unable to obtain the print region information of the printing apparatus or the operation characteristic information of the die cutting apparatus, the obtaining unit obtains the print region information of the printing apparatus or the operation characteristic information of the die cutting apparatus through the input reception unit.

13. A method of controlling an information processing apparatus configured to edit print data including cut line layer data used in die cutting of a printed medium, the method comprising:
obtaining print region information, including at least a paper feeding amount in inter-page printing, from a printing apparatus configured to perform the printing on the print medium and obtaining operation characteristic information of a die cutting apparatus from the die cutting apparatus; and
determining the cut line layer data based on the print region information and the operation characteristic information.

14. A non-transitory computer readable storage medium storing a program which causes a computer to execute a method of controlling an information processing apparatus configured to edit print data including cut line layer data used in die cutting of a printed medium, the method comprising:
obtaining print region information, including at least a paper feeding amount in inter-page printing, from a printing apparatus configured to perform the printing on the print medium and obtaining operation characteristic information of a die cutting apparatus from the die cutting apparatus; and
determining the cut line layer data based on the print region information and the operation characteristic information.
